(19) United States
(12) Patent Application Publication
(10) Pub. No.: US 2010/0235298 A1
(43) Pub. Date: Sep. 16, 2010

(54) METHOD AND APPARATUS FOR ANALYSING INVESTMENT PORTFOLIOS CONSIDERING RETURN AND RISK

(76) Inventors: William Giles Campbell, III, Yorba Linda, CA (US); Alan Ray Young, Orange, CA (US)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/722,701

(22) Filed: Mar. 12, 2010

Related U.S. Application Data
(60) Provisional application No. 61/159,518, filed on Mar. 12, 2009.

(51) Int. Cl. G06Q 40/00

(52) U.S. Cl. 705/36 R

(57) ABSTRACT

A method and apparatus is provided for use by an investor to analyze investments in a user's portfolio of investments. The method assists an investor in determining the proper mix of investments such as securities to hold in their investment portfolio to achieve an acceptable mix of investment risk and investment return. The investment risk and return data are analyzed and an investment portfolio is constructed that meets the investor's criteria.

### CROSS-REFERENCE TO RELATED APPLICATION

This application claims the benefit of U.S. Provisional Patent Application Ser. No. 61/159,518, filed Mar. 12, 2009, which is incorporated by reference herein.

### BACKGROUND OF THE INVENTION

1. Field of the Invention

The present invention relates generally to method and apparatus including a computer system and computer software that analyzes investment portfolios, considering both investment return and investment risk.

2. Description of the Related Art

Current investment analysis systems have a number of shortcomings. Many of them do not automatically import current security or investment data in real time, making them difficult and extremely time-consuming to use. Many of them homogenize security or investment data into broad asset classes, making it impossible to construct a portfolio of investments using available investments such as securities. Many of them do not allow the investor to specify criteria (such as desired risk level, desired method for measuring risk, or desired return level) that the investment portfolio must meet. Many do not have an easy-to-use interface that facilitates the input and output of data.

### SUMMARY OF THE INVENTION

The present invention provides, in one embodiment, a method and apparatus for use by an investor to analyze investments in a user's portfolio of investments. Many investors do not have the ability to determine the proper mix of investments such as securities to hold in their investment portfolio to achieve an acceptable mix of investment risk and investment return. The present invention analyzes investment risk and return data and constructs investment portfolios that meet the investor's criteria.

References to investments may include equities and other securities, bonds, commodities, options, futures or other derivative instruments or other investments. With regard to the present invention, the term investment may include a single investment or a plurality of investments which among others may include cash, liquid assets, illiquid assets pledged or otherwise collateralized, credit, or general obligation of the investor. The term investments includes any tradable interest having a value and capable of being obtained, changing in value or price, and being traded.

The present method may be embodied in software operating on a computer system and/or stored as a computer executable program on tangible computer readable media. The present apparatus may include a computer system or may be a computer software product such as a computer readable medium on which is stored the computer software

### BRIEF DESCRIPTION OF THE DRAWINGS

FIG. 1 is a first portion of a flow chart illustrating the steps performed according to one embodiment of the method for analyzing an investment portfolio according to the principles of the present invention where connection points to the flowchart of FIG. 2 are marked by letters A and C;

FIG. 2 is a second portion of a flow chart showing the method of the present invention where connection points to the flowchart of FIG. 1 are marked by letters A and C;

FIG. 3 is a flow chart showing further steps of the method;

FIG. 4 is a block diagram showing computer systems used to perform embodiments of the present method;

FIG. 5 is a computer display screen shot showing an efficient frontier graph according to the principles of the present invention;

FIG. 6 is a computer display screen shot showing a summary of data pertaining to a portfolio being analyzed using the present invention, along with controls available to the user to operate the present invention.

### DETAILED DESCRIPTION OF THE PREFERRED EMBODIMENTS

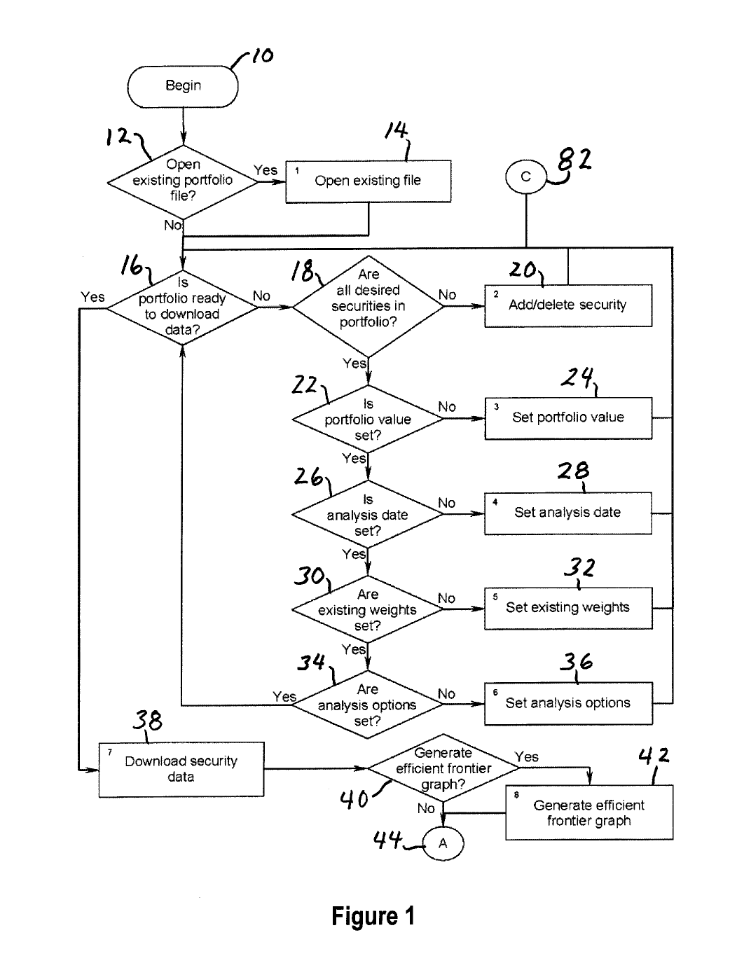

Referring now to the drawings, there is shown in FIG. 1 steps of a method that is started at a beginning element 10 when a user selects a command in software instructing the analysis to begin. The user command is input by the user operating a user input device, such as a keyboard, mouse or other pointing device, connected either by wire or wirelessly to the computer on which the software is running. A check is made at step 12 to determine if the user has a portfolio of investments and that portfolio information is stored as a file on computer readable storage media accessible to the computer. If the result of the check for an existing portfolio file is affirmative, the existing portfolio file is opened, as indicated at 14. In this step, the user can choose to open a previously saved portfolio file by selecting the portfolio file from a list of existing portfolio files. The list of existing files may be a pull down list or a list opened in a separate window. Other ways of opening an existing file are also possible and are encompassed here.

The user may elect to start a new portfolio at this point in the method. For instance, the inquiry about opening an existing file may be phrased and operated to open an existing file or open a new file.

Following the opening of the existing file, if any, a determination is made at 16 as to whether the portfolio is ready to download data. If the answer is no, a determination is made at 18 as to whether all desired securities are in the portfolio at 18. If not, securities are added and/or deleted at step 20. In this step, the user can choose to add a security to the current portfolio, or to delete a security from the current portfolio. If no changes need to be made, the process bypasses step 20 and continues.

To add a security to the portfolio the user enters an identifier (e.g., ticker symbol) for the security and proposes it for addition. The software of the present invention checks to make certain that pricing data are available for this security, and checks to make certain that this security is not already in the current portfolio. If the security passes both checks, the present invention adds it to the current portfolio. To delete a security from the current portfolio the user enters an identifier (e.g., ticker symbol) for the security and proposes it for deletion. The present software checks to make certain that this security is in the current portfolio; if so, the present invention deletes it from the current portfolio.

The present software also includes a command in conjunction with this step to clear the current portfolio; this removes all of the securities in the portfolio, sets the monetary value of the portfolio to zero, and sets the analysis date to the current date.

Once any changes in the securities in the portfolio have made, the process loops back through steps 16 and 18 to a step 22 of determining if the portfolio value has been set. If the value is not set, at step 24 the user can choose to set the monetary value of the portfolio. The user enters a monetary value for the portfolio. The present software checks to make certain that the monetary value is positive. In one embodiment, the default value for the portfolio is zero, so this must be changed. If step 22 determines that the value has been set, the method bypasses step 24 and continues.

Once the value is set, the software loops back through steps 16, 18 and 22 to a determination at step 26 of whether the analysis date is set. If no date is set, the process sets the date. A default value of one embodiment is the date that the portfolio file was created. The setting of the analysis date at step 28 is performed by the user choosing a desired date as of which to perform the analyses of the current portfolio. The user enters the desired analysis date. The present invention checks to make certain that the analysis date entered by the user is not in the future.

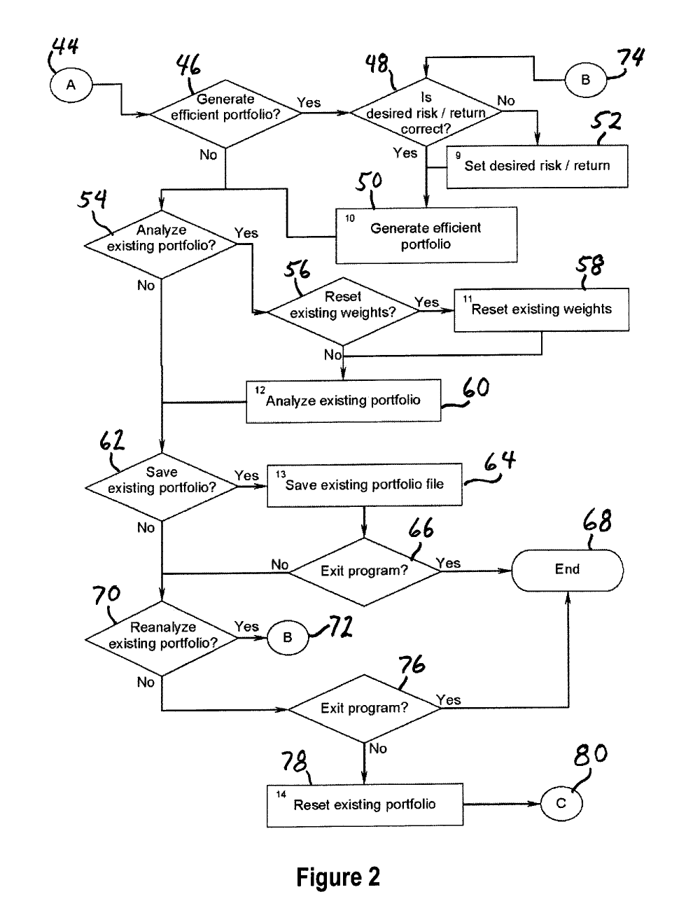

Upon completion of step 28 if necessary, the method loops through steps 16, 18, 22 and 26 and to an inquiry at step 30 of whether existing weights have been set. If so, the method continues. If not, the process moves to step 32 where the user can choose to set the relative weights of the securities that constitute the current portfolio. The user enters desired relative values for the weight of each security. The default value in one embodiment is to set equal weights for all securities in the portfolio if not changed by the user. When the existing portfolio is analyzed (in a step 60 shown in FIG. 2), the present software computes the monetary value to assign to each security so that the relative values agree with the user-assigned relative weights and the total value equals the monetary value of the portfolio (step 24, above).

After existing weights are set at step 32, the process loops through steps 16, 18, 22, 26, and 30 to a determination of whether analysis options are set at step 34. If so, the process returns to step 16 and has reached the state of being ready to download data. If not, the analysis options are set at 36. To set the analysis options, the user can choose to change any of the available analysis options (also called model options). The model options include, but are not limited to, the optimization method, the frequency of historical data, the range of historical data, the method of risk measurement, whether to use automatic pricing data error correction, the minimum holding limit on individual securities, the maximum holding limit on individual securities, the margin requirement for short sales, and whether any benchmark indices are to be analyzed. Default values for the analysis options are provided by an embodiment of the software that have provided acceptable results. As such, this step is optional.

The optimization methods include, but are not limited to, minimizing the portfolio risk (using the risk measurement specified by the user, as described below)) given a specific level of portfolio annual return, or maximizing the portfolio annual return given a specified level of portfolio risk (using the risk measurement specified by the user (see below)). Other methods of optimization, such as maximizing the expected-annual-return-minus-n-standard-deviations-of-annual-returns (where n—the number of standard deviations of returns used—is specified by the user) are possible.

The frequency of historical data is monthly in the current embodiment, but other frequencies (e.g., daily, weekly, bi-monthly, quarterly, semiannually, annually, or others) are possible.

The minimum amount of historical data necessary is two periods (where the period is determined by the frequency of the historical data as specified by the user, above; e.g., two days for daily data, two weeks for weekly data, and so on). The maximum amount of data available is the largest range for which the invention can download price data for all of the securities selected to be in the portfolio. The range of historical data that the user can select can be anywhere from the minimum required (two periods) to the maximum available.

The methods of risk measurement include calculation of the standard deviation of portfolio returns, lower semi-deviation of portfolio returns, and semi-deviation of portfolio returns below a target return (with the target return supplied by the user). Possible additional methods of risk measurement include, but are not limited to, determining value at risk (VAR), and probability of loss of a certain percentage of portfolio value (e.g., probability of losing 50% of the value of the portfolio).

The user can decide whether or not to let the present software detect and correct apparent errors in security pricing data as those data are downloaded. If pricing error correction is selected, the present invention assumes that the nature of a pricing error is a misplaced decimal point. For each security in the portfolio the present invention, beginning with the earliest security price, divides each period's price by the preceding period's price. If that quotient exceeds 10^{1.5} (≈31.6), the present invention “corrects” the current period's price by dividing it by 10. It then repeats the quotient calculation and correction of the current period's price until the quotient does not exceed 10^{1.5}. This process is then repeated with each succeeding period's price until the most recent price is reached. When the present invention “corrects” any security price, it informs the user that the price data for that security have been corrected.

The minimum holding limit is the minimum percentage of the portfolio value that can be allocated to a security. This value can be negative (allowing the portfolio to sell short), zero, or positive, and is supplied by the user. A single limit can be applied to all securities in the portfolio, or, possibly, different limits can be applied to individual securities or groups of securities. The present invention will make certain that the aggregate minimum limit is less than 100%.

If the minimum holding limit is negative, the present invention allows the user to specify the margin requirement for short sales (i.e., the percentage of the proceeds from a short sale that must remain in the brokerage account as surety against adverse price movement).

The maximum holding limit is the maximum percentage of the portfolio value that can be allocated to a security. This value must be positive, and is supplied by the user. A single limit can be applied to all securities in the portfolio, or, possibly, different limits can be applied to individual securities or groups of securities. The present invention will make certain that the aggregate maximum limit is greater than 100%.

The available benchmark indices include, but are not limited to, the Dow Jones Industrial Average, the NASDAQ Composite Index, the NYSE Composite Index, the S&P 500 Index, and the 10-Year U.S. Treasury Note.

Once the analysis options are set at step 36, the method loops back to step 16, where the portfolio has now been determined to be ready to download data.

The method continues to step 38, where the security data are downloaded. The present software downloads pricing data via a network connection, for example, to an exchange, market data vendor, data clearinghouse or other source, for all of the individual securities in the portfolio. These pricing data include, but are not limited to, monthly closing prices on each security. The data can be downloaded from Internet financial data sources (e.g., Yahoo! Finance, Google Finance, and so on), or, possibly, from user-supplied pricing data in computer data files (such as Excel files), or possibly from other data sources. The present invention downloads the pricing data into an appropriate computer storage medium, combines the data to produce return data for the portfolio, and computes risk and return statistics for the portfolio, as well as other statistics including, but not limited to, correlations of returns between all pairs of securities in the portfolio. If the user has selected automatic pricing data error correction, the present invention applies an algorithm as it is downloading the pricing data to detect and correct apparent errors in the source pricing data. Downloading of the security data is considered a necessary step of the method, according to the preferred embodiment.

With the market data in place, the method proceeds to step 40, where a question is posed to the user as to whether to generate an efficient frontier graph. If not, the process continues. If the user enters the optional command to generate the graph, the graph is generated at step 42. In particular the present software generates and plots the efficient frontier graph, which is all of the risk/return points corresponding to portfolios having minimum risk for a given level of return, and maximum return for a given level of risk. On the same graph, the present software plots the risk/return points for the individual securities in the user's portfolio, and for the portfolio itself, as well as for any benchmark indices that the user has chosen. The graph is optional in the present embodiment.

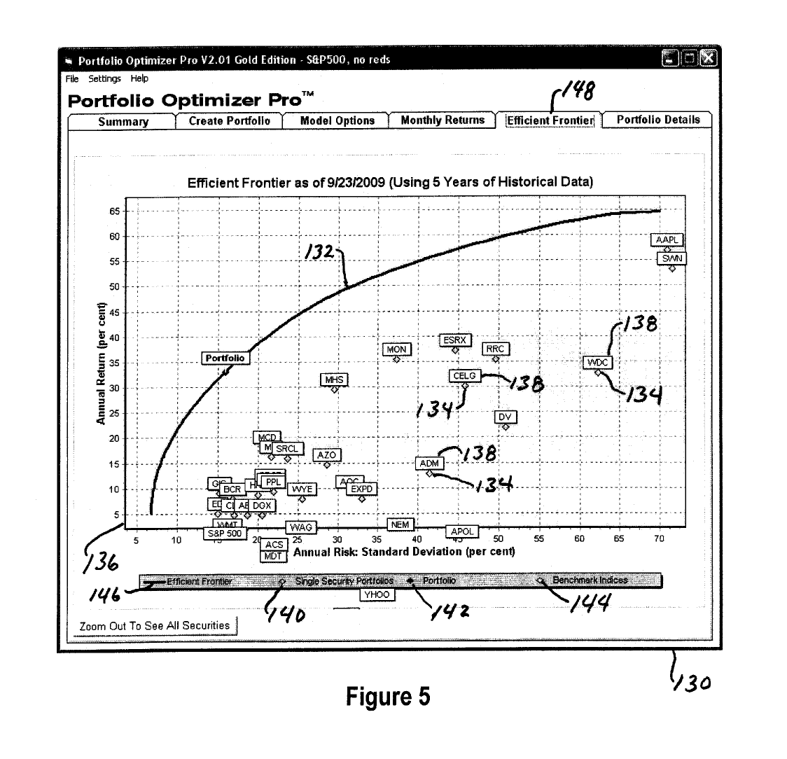

FIG. 5 shows a screen shot 130 of an efficient frontier graph 132 generated according to a preferred embodiment of the invention. The efficient frontier graph 132 plots the annual return in percent against the user-selected annual risk measure (annualized standard deviation of monthly returns, in percent, in this example). Investments in the portfolio are marked as points 134 on a graph 136 and each point 134 is labeled with an indicator 138 of the investment, such as the ticker symbol. The plotted points 134 are indicated with symbols that indicate the character of the graphed investment. In the example, the graphed points 134 are diamond shapes that are filled with colors to indicate the nature of the investment. In one example, green filled diamonds 140 indicates single security portfolios, red filled diamonds 142 indicates portfolios, and yellow filled diamonds 144 indicate benchmark indices. A line 146 is generated on the graph to indicate an efficient frontier of the return/risk space, as indicated at 132 on the example graph 136. The line 146 indicates an efficient frontier of return and risk combinations for the portfolio. The frontier graph 132 is displayed to the user upon selection of an efficient frontier tab 148 at the top of the display. Other tabs are provided as will be discussed below. The display 130 is shown for a computer using the Microsoft Windows operating system. Other operating systems, such as Macintosh or Linux are also possible.

The flow chart of FIG. 1 has reached point A at 44 where the flow chart continues to point A in FIG. 2. From point A at 44, the determination is made at step 46 whether the user wishes to generate an efficient portfolio. If the user selects the option to generate the efficient portfolio at 46, an inquiry is made as to whether the desired risk and return ratio are correct, at 48. If the desired risk/return is correct, the process continues to step 50 where an efficient portfolio is generated.

The efficient portfolio generating step 50 employs an algorithm to generate a set of weights for the securities in the user's portfolio that achieves the chosen optimization subject to all of the user-supplied constraints. If, for example, the method of optimization is to minimize the portfolio risk given a desired portfolio return, then the algorithm will generate a set weights for the portfolio securities so that the resulting portfolio has the minimum portfolio risk (using the risk measure chosen by the user) while having a portfolio return greater than or equal to the user's desired portfolio return, subject to the constraints on security holding limits (minimum and maximum, as supplied by the user). The present software will then display the monetary value of each security corresponding to its weight in the portfolio, the percent of the total portfolio monetary value represented by each of the individual securities' monetary values, the risk and return for that portfolio, and various other statistics about that portfolio.

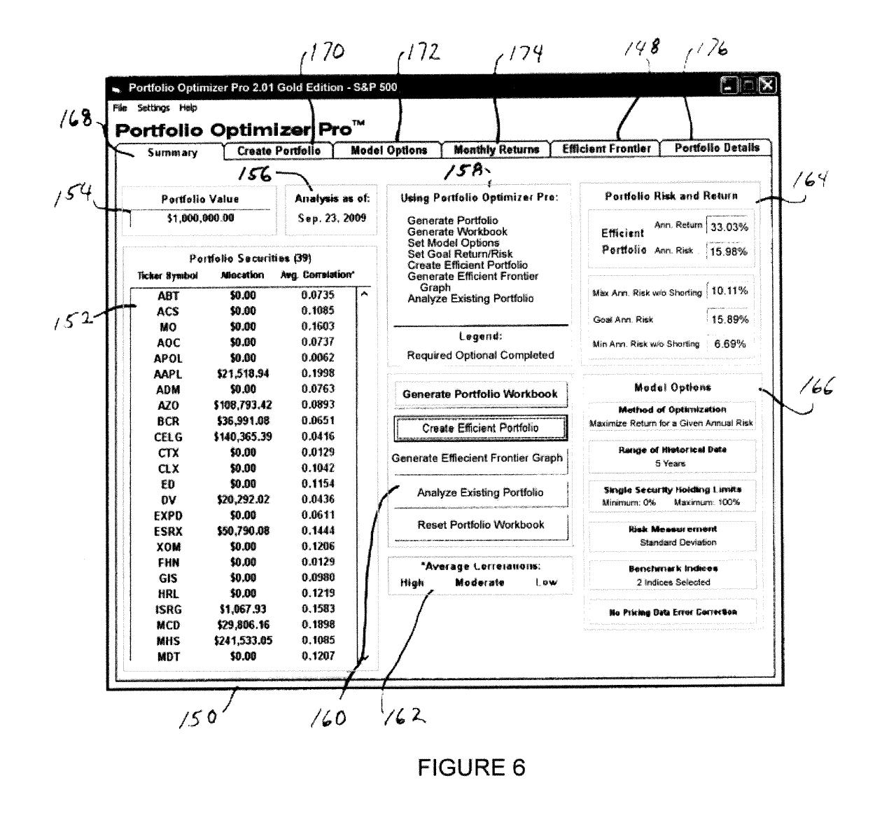

The algorithm used is a linear or non-linear optimization subject to linear or non-linear constraints. One embodiment of this algorithm is implemented using the Solver add-in included in the Microsoft Excel program. Other embodiments are possible. The result of the implementation of this algorithm is shown in screen images in FIGS. 5 and 6. FIG. 6 shows a screen shot 150 with a partial list 152 of the securities (sorted by ticker symbol) included in the portfolio along with their respective monetary values under the heading “Portfolio Securities”, on the far left. Above the list 152 is a window 154 showing the portfolio monetary value and a date 156 showing the date of the analysis. Also provided is a user guide 158 that identifies functions that can be performed using the software, including creating a portfolio, generating a workbook, setting model options, setting goal return and risk values, creating an efficient portfolio, generating an efficient frontier graph and analyzing an existing portfolio. Color coding is provided to indicate which of those functions are required, which are optional and which have been completed. Buttons 160 are provided to initiate those functions, including buttons for generating a portfolio workbook, creating an efficient portfolio, generating an efficient frontier graph, analyzing an existing portfolio, and resetting the portfolio workbook. Below the buttons 160 is a legend 162 for average correlations, indicating by color a qualitative assessment of the correlation numbers included in list 152; possible qualitative assessments are high, moderate and low. To the right in the screen shot is a portfolio risk and return area 164. Numerical values of return and risk are provided for the current portfolio and a range of possible risk/return values defined by minimum and maximum risk/return values along with a goal risk/return value is set forth. Below the risk and return area is a summary of model options 166. The user may set the method of optimization, range of historical data, single security holding limits, risk measurement, benchmark indices and whether or not to allow pricing data error correction. The view of the illustrated screen shot is available by selecting the summary tab 168 at the top of the display. Other tabs include create portfolio 170, model options 172, monthly returns 174, efficient frontier 148 (as discussed above), and portfolio details 176.

The FIG. 5 showing a plot 136 of the risk versus return of the resulting portfolio (labeled “Portfolio”) compared to the risk versus return values for the individual securities 134 (labeled by their respective ticker symbols 138) and to the efficient frontier (the solid black line 132).

Returning to FIG. 2, if the determination is made at step 48 that the desired risk/return is not correct, the process activates step 52 in which the desired risk and return is set. The user can choose to set the risk/return constraint to the desired level, by entering the appropriate value. The type of constraint entered depends on the method of optimization being employed. If, for example, the method of optimization is to minimize the portfolio risk given a desired portfolio return, then the constraint will be the desired portfolio return; if the method of optimization is to maximize the portfolio return given a desired level of portfolio risk, then the constraint will be the desired portfolio risk.

After the setting of the risk/return at step 52, the method continues to the generation of the efficient portfolio at step 50, as described above.

When the efficient portfolio has been generated, or if the user chooses not to generate an efficient portfolio at step 46, the method continues to step 54 in which the user is asked whether the existing portfolio is to be analyzed. If the user chooses to have the software analyze the existing portfolio, the process then requests that the user wishes to reset existing weights in the portfolio at step 56. Assuming that the user selects the affirmative, the method moves to step 58. At 58 the software the user can choose to change the weights on the existing portfolio. The user enters desired relative values for the weight of each security. When the existing portfolio is analyzed (see step 60, below), the present method computes the monetary value to assign to each security so that the relative values agree with the user-assigned relative weights and the total value equals the monetary value of the portfolio as determined for example in step 24, above.

After the weights of the existing portfolio have been reset at step 58 or if the option to reset the weights has been declined at 56, the method continues to step 60, where and analysis is performed of the existing portfolio. The analysis of the existing portfolio will cause the present software to display the monetary value of each security corresponding to its weight in the portfolio, the risk and return on that portfolio, and various other statistics about that portfolio, including, but not limited to, average correlations of returns of each security with the remaining securities in the portfolio, overall average correlation of returns of each pair of securities, historical annual return for each security, historical annualized standard deviation of returns for each security, length of historical data for each security, historical annual return for each benchmark selected, historical annualized standard deviation of returns for each benchmark selected, and length of historical data for each benchmark selected.

After step 60 or step 54, the method continues to an inquiry to the user asking if the user wishes to save the existing portfolio, at step 62. An affirmative response by the user moves the program to step 64 where the existing portfolio is saved. The user can choose to save on a computer storage device a file containing all of the information about the current portfolio. The present invention allows the user to enter an appropriate file name for the portfolio data, then saves the information about the current portfolio, including, but not limited to, all of the model options selected by the user, all of the constraints provided by the user, all of the historical pricing data downloaded by the present invention, and all of the security weights in place at the time the user chooses to the saved file. The user chooses the name and location of the saved file, or may permit the software to select a next consecutive name, for example, and a default save location for the file.

The portfolio information may be saved by the user at any time during the process. The model options and other values may also be changed by the user at any or nearly any stage during use of the program, including changing any previously stored values.

After saving the file at 64, the program asks the user if the user wishes to exit the program at step 66. If the answer is affirmative, the program is ended at 68. If the save function is not selected, or if the user does not wish to exit the program after saving, the method moves to step 70 where the user is asked if the user wishes to reanalyze the existing portfolio. If the answer is yes, the method loops back to step 48 as indicated by jump point B at 72 and a corresponding jump point B at 74. If no reanalysis is selected at 70 the user is asked if they wish to exit the program at 76. If yes, the program is ended at 68; if not, the program moves to step 78 where the portfolio is reset. The user may be asked at step 76 if the user wishes to exit the program or reset the portfolio.

Step 78, reset of the existing portfolio, allows the user to choose to reset the existing portfolio, which is necessary if the user should desire to change the securities that are included in the portfolio, change the monetary value of the portfolio, change the analysis date for the portfolio, or change the benchmark indices that are analyzed alongside the portfolio. The reset of the existing portfolio causes the present software to remove the downloaded security pricing data and allows the user to continue with step 20, where the user has the option to add and/or delete one or more securities, as noted above, as indicated by the link point C at 80 in FIG. 2 that links to link point C in FIG. 1 at 82.

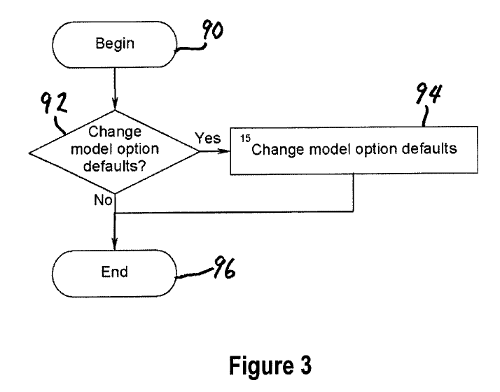

Turning to FIG. 3, a process is set out in a separate flow chart, wherein the process is begun at 90 and moves to an inquiry at 92 as to whether the user wishes to change model option defaults, which is performed at step 94. The user can save to a computer storage device the default values for all of the model options, and can change any of the default values previously stored. The present software will then use these values unless changed by the user or unless they are incompatible with the data downloaded for the existing portfolio. The method ends at step 96 either with the model option defaults changed or not.

The model options and the source of the model options are described above.

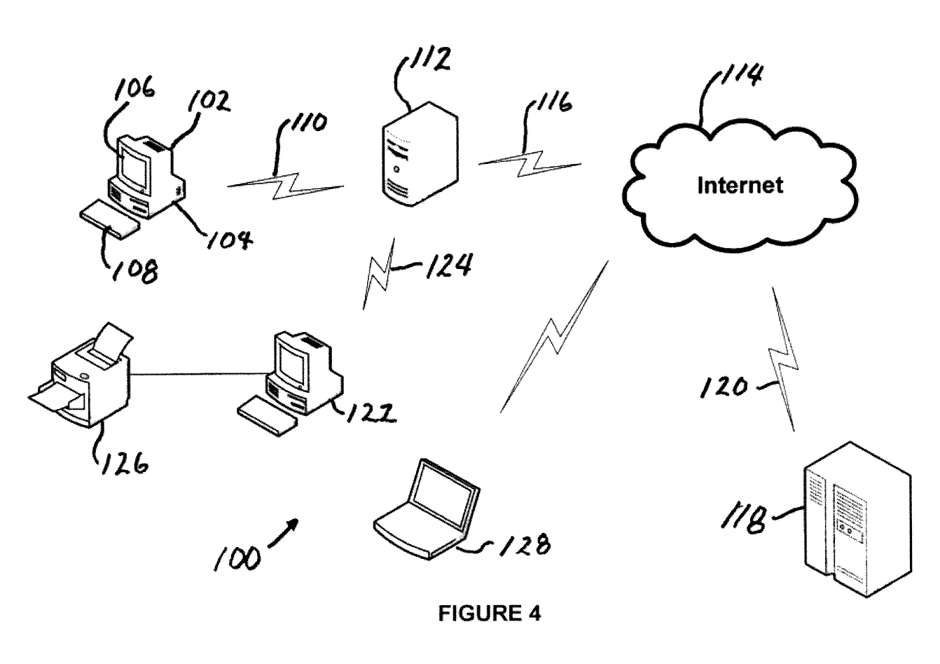

FIG. 4 is a schematic representation of a computer system on which software for performing the present method may be operated. The computer system 100 includes at least one computer 102 on which the software is operated to perform the present method. The computer 102 includes a microprocessor and other computer circuitry along with tangible computer readable storage media on which is stored software, possibly including the present software, in a housing 104 and includes or is connected to a user interface that may include a display screen 106 and a user input such as a keyboard 108 and mouse or other pointer device. The computer 102 is connected by a communication link 110 to a router 112 that in turn is connected to the Internet 114 by a communication link 116. An exchange or other information source includes a computer system 118 on which are stored data on securities or other investment instruments. The computer system 118 is connected via a communication link 120 to the Internet 114 so that the security data may be transmitted to the computer 102 when requested.

The software of the present method may be stored locally on the computer 102 or on the server 112, or may be stored in distributed fashion accessible on the Internet 114 in what is termed cloud computing. The communication links 110, 116 and 120 may be wired or wireless communication links. Other users may use the present software such as via a computer 122 that is connected to the server 112 via a communication link 124. The user of the computer 122 may choose to output the graph and other data provided in the method on a printer 126 connected to the computer 122. The computer 122 may be a workstation, kiosk or other computer device. The printer 126 may be connected by wire or wirelessly to the computer 122 directly or via the server 112. Another user operates the software on a portable computer device 128, such as a laptop computer, notebook computer, tablet computer, netbook computer, or other computer device, such as a smart phone, PDA, email or Internet enabled device, or other portable electronic device.

The present apparatus may include one or more such computer devices on which the software is operated and/or stored. The present apparatus may include tangible computer readable media on which the executable software for performing the present method is stored, including computer hard discs, solid state media such as semiconductor storage memory, removable media such as optical discs, magnetic discs, magnetic tapes, and all such media on which the software may be stored and from which it may be read. The software may be written in any computer language, such as C++, SQL, XML, JAVA, HTML, BASIC or derivatives thereof or other computer language.

Variations in the relationships between the steps or elements or in the order of the steps performed according to the present method are possible and all such variations are within the scope of the present invention. For example, when the user is creating a new portfolio or modifying an existing portfolio, steps 20, 24, 28, and 36 can be performed in any order. In other words, the user may select to access any of these steps directly rather than proceeding through each in the illustrated order. Step 32 setting the existing weights must follow step 20 of adding or deleting securities, but it need not follow it immediately (i.e., a particular security must be added to the portfolio before the weight of that security can be added).

Steps 42, 58, 60, 64, and 78 can be performed in any order once the security data has been downloaded at step 38. Step 52 which sets the desired risk or return must precede step 50 where the efficient profile is generated as the step 50 depends on the value entered in the step 52. Multiple iterations of steps 52 and 50 are possible at any time after the step 38 of downloading the security data.

Should the step 24 of setting the portfolio values be omitted, the present software will default to equal weights on all securities in the portfolio. Should the step 28 of setting the analysis date, the step 36 of setting the analysis options or the step 52 of setting the desired risk and return be omitted, the present software will supply default values.

The step 94 of changing the model option defaults as shown on FIG. 3 is independent of the other steps and can be performed at any time.

Following is additional disclosure of how the software that embodies the present method and apparatus works.

Once the user has determined to either open an existing portfolio file or start a new portfolio, the software then determines whether the portfolio (either an existing or new portfolio) could be ready to download security pricing data. The present software determines if there are at least two securities in the portfolio, and if the portfolio has a positive monetary value. The user also determines whether the portfolio is ready to download security pricing data by deciding if the portfolio contains all of the securities desired by the user, if the portfolio has the proper monetary value, if the proper analysis date is set, if the proper (relative) security weights for the existing portfolio are set, and if the proper analysis (modeling) options are set.

If the user determines that the current portfolio does not contain the proper set of securities, the user can add a new security to or delete an existing security from the current portfolio, at step 20. To add a security to the portfolio the user enters an identifier (e.g., ticker symbol) for the security and proposes it for addition. The present software checks to make certain that pricing data are available for this security, and checks to make certain that this security is not already in the current portfolio. If the security passes both checks, the present invention adds it to the current portfolio. To delete a security from the current portfolio the user enters an identifier (e.g., ticker symbol) for the security and proposes it for deletion. The present invention checks to make certain that this security is in the current portfolio; if so, the present software deletes it from the current portfolio.

The software also includes a function or method to clear the current portfolio; this removes all of the securities in the portfolio, sets the monetary value of the portfolio to zero, and sets the analysis date to the current date.

If the user determines that the monetary value of the portfolio is incorrect, the user enters the correct monetary value, at step 24. The software checks to make certain that the monetary value is positive.

If the user determines that the analysis date is not correct, the user enters the correct analysis date at step 28. The software checks to make certain that the analysis date is not in the future.

If the user wants the existing portfolio to have certain (relative) weights, the user enters appropriate relative values for the weight of each security, as shown at step 32. When the existing portfolio is analyzed (as performed at step 60, below), the software computes the monetary value to assign to each security so that the relative values agree with the user-assigned relative weights and the total value equals the monetary value of the portfolio, as in step 24.

If the user determines that the current analysis options (also called model options) are incorrect or require some change, the user enters appropriate values for the options, as shown in step 36. The model options include, but are not limited to, the optimization method, the range of historical data, the method of risk measurement, whether to use automatic pricing data error correction, the minimum holding limit on securities, the maximum holding limit on securities, and whether any benchmark indices are to be analyzed.

The optimization methods include, but are not limited to, minimizing the portfolio risk given a specific level of portfolio return, or maximizing the portfolio return given a specified level of portfolio risk.

The range of historical data can be anywhere from a minimum of two months to a maximum that is determined by the amount of historical pricing data that are available for the securities included in the user's portfolio (the maximum range being the minimum of the amount of historical pricing data for each of the securities in the portfolio; i.e., the largest range for which all of the securities have pricing data).

The method of risk measurement includes standard deviation of portfolio returns, lower semi-standard deviation of portfolio returns, and semi-deviation below a target return (with the target return supplied by the user). Possible additional methods of risk measurement include, but are not limited to, value at risk (VAR), and probability of loss of a certain percentage of portfolio value (e.g., probability of losing 50% of the value of the portfolio).

The user can decide whether or not to let the present invention detect and correct errors in security pricing data as those data are downloaded.

The minimum holding limit is the minimum percentage of the portfolio value that can be allocated to a security. This value can be negative (allowing the portfolio to sell short), zero, or positive, and is supplied by the user. A single limit can be applied to all securities in the portfolio, or, possibly, different limits can be applied to individual securities or groups of securities. The present invention will make certain that the aggregate minimum limit is less than 100%.

The maximum holding limit is the maximum percentage of the portfolio value that can be allocated to a security. This value must be positive, and is supplied by the user. A single limit can be applied to all securities in the portfolio, or, possibly, different limits can be applied to individual securities or groups of securities. The present invention will make certain that the aggregate maximum limit is greater than 100%.

The available benchmark indices include, but are not limited to, the Dow Jones Industrial Average, the NASDAQ Composite Index, the NYSE Composite Index, the S&P 500 Index, and the 10-Year U.S. Treasury Note.

Once the portfolio is ready to download data, the present invention downloads pricing data for all of the individual securities in the portfolio, as in step 38. These pricing data include, but are not limited to, monthly closing prices on each security. The data can be downloaded from internet financial data sources (e.g., Yahoo! Finance, Google Finance, and so on), or, possibly, from user-supplied pricing data in computer data files (such as Excel files), or possibly from other data sources. The present invention downloads the pricing data into an appropriate computer storage medium, combines the data to produce return data for the portfolio, and computes risk and return statistics for the portfolio, as well as other statistics including, but not limited to, correlations of returns between securities in the portfolio. If the user has selected automatic pricing data error correction, the present invention applies an algorithm as it is downloading the pricing data to detect and correct errors in the source pricing data.

After the data are downloaded at step 38, the user can choose to generate an efficient frontier graph. If so, the present invention generates and plots the efficient frontier graph at step 42, which is all of the risk/return points corresponding to portfolios having minimum risk for a given level of return, and maximum return for a given level of risk. On the same graph the present invention plots the risk/return points for the individual securities in the user's portfolio, and for the portfolio itself, as well as for any benchmark indices that the user has chosen.

Once the security data are downloaded at step 42, the user can choose to generate an efficient portfolio. If so, the user can check to see if the proper risk/return constraint is being used, and, if not, can set the risk and/or return constraint to the desired level at step 52 by entering the appropriate value. The type of constraint entered depends on the method of optimization being employed. If, for example, the method of optimization is to minimize the portfolio risk given a desired portfolio return, then the constraint will be the desired portfolio return; if the method of optimization is to maximize the portfolio return given a desired level of portfolio risk, then the constraint will be the desired portfolio risk.

When the user chooses to generate an efficient portfolio, the present invention employs an algorithm to generate a set of weights for the securities in the user's portfolio that achieves the chosen optimization subject to all of the user-supplied constraints at step 50. If, for example, the method of optimization is to minimize the portfolio risk given a desired portfolio return, then the algorithm will generate a set weights for the portfolio securities so that the resulting portfolio has the minimum portfolio risk (using the risk measure chosen by the user) while having a portfolio return greater than or equal to the user's desired portfolio return, subject to the constraints on security holding limits (minimum and maximum, as supplied by the user). The present invention will then display the monetary value of each security corresponding to its weight in the portfolio, the risk and return on that portfolio, and various other statistics about that portfolio.

The user can choose to change the weights on the existing portfolio at step 58, and reanalyze the existing portfolio at step 60. The analysis of the existing portfolio will cause the present invention to display the monetary value of each security corresponding to its weight in the portfolio, the risk and return on that portfolio, and various other statistics about that portfolio.

The user can choose to save on a computer storage device a file containing all of the information about the current portfolio at step 64, including, but limited to, all of the model options selected by the user, all of the constraints provided by the user, all of the historical pricing data downloaded by the present invention, and all of the security weights in place at the time the user chooses to save the file.

If the user should desire to change the securities that are included in the portfolio, change the monetary value of the portfolio, change the analysis date for the portfolio, or change the benchmark indices that are analyzed alongside the portfolio, the user must reset the existing portfolio, as shown at step 78. This removes the downloaded security pricing data and allows the user to continue with step 20.

At any time the user can save to a computer storage device default values for all of the model options, and can change any of the default values previously stored as shown at step 94. These default values will then be used by the present invention unless changed by the user or unless they are incompatible with the data downloaded for the existing portfolio.

The following describes which steps are necessary and which steps are optional elements of the method. Opening an existing portfolio file, at step 14, is optional; the user can always start with a new (or empty) portfolio should he or she so chooses. Adding securities, at step 20, is necessary to get at least two securities in the portfolio; after that, adding and deleting securities is at the discretion of the user. Setting a portfolio value that is positive, at step 24, is necessary; the default value is zero and must be changed. Setting the analysis date, at step 28, is optional; the default analysis date is the date the portfolio file is created. Setting weights for the existing portfolio, at step 32, is optional; the default values will be equal weights for all securities in the portfolio. Setting the analysis options, at step 36, is optional; the present invention will supply acceptable default values for all of the analysis options. Downloading the security pricing data at step 38 is necessary. Generating the efficient frontier graph at step 42 is optional to the method. Setting the desired risk and return at step 52 is optional, but the efficient portfolio generated in step 50 will depend on this value. In practice, it is rarely omitted. Generating an efficient portfolio at step 50 is optional, but is generally the result the user desires; i.e., the general reason to use the present software is to generate an efficient portfolio. In practice, this step is rarely omitted. Resetting the weights on the existing portfolio at step 58 is optional. Analyzing the existing portfolio at step 60 is optional. Saving the existing portfolio file at step 64 is optional, but rarely omitted. Resetting the existing portfolio at step 78 is optional. Changing the analysis option (also known as the model option) defaults at step 94 is optional.

The following sets forth a scenario an example of how a user might use the present software. The user first decides whether to open an existing portfolio file that is stored on a computer storage device, or to create a new portfolio. If the user chooses to open an existing portfolio file, the user selects a file from a list provided by the software. The user decides if the portfolio contains all of the securities desired by the user, if the portfolio has the proper monetary value, if the proper analysis date is set, if the proper (relative) security weights for the existing portfolio are set, and if the proper analysis (modeling) options are set.

If the user determines that the current portfolio does not contain the proper set of securities, the user can add a new security to or delete an existing security from the current portfolio. To add a security to the portfolio the user enters an identifier (e.g., ticker symbol) for the security and proposes it for addition. To delete a security from the current portfolio the user enters an identifier (e.g., ticker symbol) for the security and proposes it for deletion. If the user determines that the monetary value of the portfolio is incorrect, the user enters the correct monetary value. If the user determines that the analysis date is not correct, the user enters the correct analysis date. If the user wants the existing portfolio to have certain (relative) weights, the user enters appropriate relative values for the weight of each security. If the user determines that the current analysis options (also called “model options”) are not correct, the user enters appropriate values for the options.

After the data are downloaded, the user can choose to generate an efficient frontier graph. Once the security data are downloaded, the user can choose to generate an efficient portfolio. If so, the user can check to see if the proper risk and/or return constraint is being used, and, if not, can set the risk/return constraint to the desired level, by entering the appropriate value. The type of constraint entered depends on the method of optimization being employed. The user can choose to change the weights on the existing portfolio, and reanalyze the existing portfolio.

The user can choose to save on a computer storage device a file containing all of the information about the current portfolio, and can choose the name and location of the saved file. At any time the user can save to a computer storage device default values for all of the model options, and can change any of the default values previously stored.

The present method and software may be used in other ways. For example, the present software could be used to analyze any set of data that can be characterized as prices or values that change over time, where increases in prices or values are beneficial, and variability in those increases is considered risky. It is also envisioned to apply the present method to changing values where decreases in the values are considered beneficial. Possible applications would include, but not be limited to, analysis of projects undertaken by a business firm, analysis of benefits from a medical regimen (for example a dietary, therapeutic, or pharmaceutical regimen, and the like), as well as application to other fields.

The present software could produce efficient “portfolios” of business projects, dietary foods, therapeutic procedures, pharmaceutical medicines, and so on, where efficiency is a function of the benefit of items being analyzed and the risk (variability of benefit) of the items being analyzed.

Thus, there has been shown and described a method and apparatus by which a user may analyze a portfolio of investments and consider changes to the portfolio to obtain objectives desired by the user, such as a certain risk to return ratio or target value at a particular time.

Although other modifications and changes may be suggested by those skilled in the art, it is the intention of the inventors to embody within the patent warranted hereon all changes and modifications as reasonably and properly come within the scope of their contribution to the art.

We claim:

1. A method of configuring a portfolio of investments, comprising the steps of:
opening an existing portfolio file containing information on a portfolio of investments;
receiving changes to investments in the portfolio file, said changes including at least one of adding investments to the portfolio, removing investments from the portfolio, and changing a quantity of an investment in the portfolio;
receiving a portfolio value from a user and setting the portfolio value accordingly;
receiving an analysis date from a user on which to perform a portfolio analysis;
receiving relative weights of investments in the portfolio from the user and setting monetary values of the investments according to the weights;
receiving changes in analysis options as model options from the user and setting the analysis options accordingly, said model options including relative levels of risk and return;
downloading investment data including at least investment price for investments in the portfolio and those sought for the portfolio;
generating an efficient frontier graph of the risk and return points for the individual securities in the portfolio;
receiving desired risk or return values from the user;
generating an efficient portfolio including generating a set of weights for securities in the portfolio that meets the user supplied constraints; including the sub-steps of:
receiving relative weight values of the portfolio from the user and resetting the existing weights accordingly;
analyzing an existing portfolio by computing monetary value for each investment in the portfolio and assigning values to each investment so that the relative values agree with the relative weights and so that the total value equals the monetary value of the portfolio;
displaying monetary values for each investment corresponding to its weight in the portfolio and the risk and return values;
saving the portfolio file to tangible computer readable media;
resetting the existing portfolio file if requested by the user; and
changing model option defaults if requested by the user.
